(19) United States
(12) Patent Application Publication
(10) Pub. No.: US 2006/0015839 A1
(43) Pub. Date: Jan. 19, 2006

(54) Development of software systems

(76) Inventors: Peter Owens, Dublin (IE); Robert McCarthy, Ennis (IE)

Correspondence Address: JACOBSON HOLMAN PLLC, 400 SEVENTH STREET N.W., SUITE 600, WASHINGTON, DC, 20004, US

(21) Appl. No.: 11/231,798

(22) Filed: Sep. 22, 2005

Related U.S. Application Data
(63) Continuation of application No. PCT/IE04/00044, filed on Mar. 26, 2004.

(30) Foreign Application Priority Data
Mar. 26, 2003 (IE) 2003/0226

(51) Int. Cl. G06F 9/44

(52) U.S. Cl. 717/100; 717/110

(57) ABSTRACT

A development system has a preparation tool (2) which generates an XML configuration document (1) by automatically parsing a source database. Alternatively, or in addition, a conversion tool (3) generates the document (1) by automatically applying a conversion process. An editor tool (10) allows user editing of the XML configuration document. A framework tool generates program code strings and an architecture using the document 1. A forms tool (20) automatically generates GUI forms. A deployment tool (25) integrates the source database, the target progarm code, the target architecture and the target forms to provide a complete target system.

### 1. FIELD OF THE INVENTION

The invention relates to development of software systems, such as J2EE compliant three-tier thin-client Web-based business applications hosted on application servers.

### 2. PRIOR ART DISCUSSION

Heretofore, development of such systems has been time-consuming, requiring much skilled manual system design and code writing. Also, considerable time is required for preparation of accompanying documentation.

European Patent Specification No. EP1116104B1 describes a system for generating a client/server data processing system. The system progresses through stages from initial models to the target code.

The invention is directed towards achieving faster and simpler system development, both for ground-up development and for conversion from an existing system.

### SUMMARY OF THE INVENTION

According to the invention, there is provided a software development system for development of a target software system, the development system comprising:
a configuration sub-system for automatically generating configuration data by processing a source database or a source application, and
a framework tool for using said configuration data to automatically generate
a target system architecture and program code and for populating the architecture with the program code.

In one embodiment, the configuration sub-system comprises a preparation tool for parsing a source system database to generate the configuration data.

In another embodiment, the preparation tool extracts application-level parameter data from the source database to provide at least some of the configuration data.

In a further embodiment, the preparation tool extracts object-level and table-level parameter data from the source database including class definitions to provide at least some of the configuration data.

In one embodiment, the preparation tool loops through tables of the source database to build field-level configuration data including table names, field names, data types, and field size.

In another embodiment, records containing primary key fields are omitted.

In a further embodiment, foreign keys are included.

In one embodiment, the preparation tool generates at least some configuration data using default values in a nested selection process.

In another embodiment, the preparation tool populates the configuration document with a set of field-level parameter values corresponding to each table in a source database.

In a further embodiment, the field-level data includes default parameter settings derived from source database fields.

In one embodiment, the configuration data is in a mark-up language format in a configuration document.

In another embodiment, the configuration document has a section for each of application-level data, object and table-level data and field-level data.

In a further embodiment, the system further comprises an editor tool for generating a display of the configuration data in a navigation structure, and for allowing manual editing of selected fields of configuration data with data field-level access control.

In one embodiment, the editor tool allows a single table of the source database to be represented multiple times in the configuration data.

In another embodiment, the framework tool pre-stores standard architecture files including a request processor and request-to-event processor controller objects, and writes them to the target system architecture.

In a further embodiment, said framework tool also pre-stores helper objects and utility files and writes them to the target system architecture.

In one embodiment, the framework tool parses the field-level configuration data to generate:
a program code string for remote interface declarations,
a program code string containing record create method fields for a remote interface, and
a program code string containing record update method fields for a remote interface.

In another embodiment, the framework tool parses the field-level configuration data to generate program code containing home interface abstract declarations, to generate program code containing create and update method fields for a controller event file, and to generate program code containing parameter requests for each form field for web handler files.

In a further embodiment, the framework tool pre-stores skeleton code and writes said code to the target system architecture.

In one embodiment, the framework tool generates the target system architecture according to the Model-View-Controller paradigm, in which a model represents application data and business rules, a view accesses data, and a controller defines application behaviour.

In another embodiment, the system further comprises a forms tool for automatically building target system user interface forms.

In one embodiment, the forms tool automatically identifies field-level configuration data associated with user-editable fields, detects the nature of the user input, and generates a corresponding form control.

In another embodiment, the forms tool automatically identifies a dialog input parameter in the field-level configuration data and generates a corresponding input button for a form.

In a further embodiment, the configuration sub-system comprises a conversion tool for automatically converting source system application programs to configuration data, and the framework tool operates with said configuration data.

In one embodiment, the conversion tool stores conversion rules for operating with the source system application programs to generate the configuration data.

In another embodiment, the conversion tool parses the source application programs, applies conversion rules to said programs, applies parameter values, and performs a decomposition of the source application program schema into object-oriented entities to provide configuration data representing source application structure, database, and application fields.

In a further embodiment, the schema represents modelled source application reusable objects.

In one embodiment, the configuration sub-system comprises a default global configuration document, and an editor program to allow user editing of said document.

In another embodiment, the conversion tool comprises a default conversion rules files, and an edit program to allow user updating of migration conversion rules.

In a fixer embodiment, the conversion tool parses source system code by looping through all of a set of a conversion rules for each element of source code.

In one embodiment, one of said rules selects a corresponding parameter to insert in the configuration data.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawing in which:—

FIG. 1 is a flow diagram of operation of a software development system of the invention.

### DESCRIPTION OF THE EMBODIMENTS

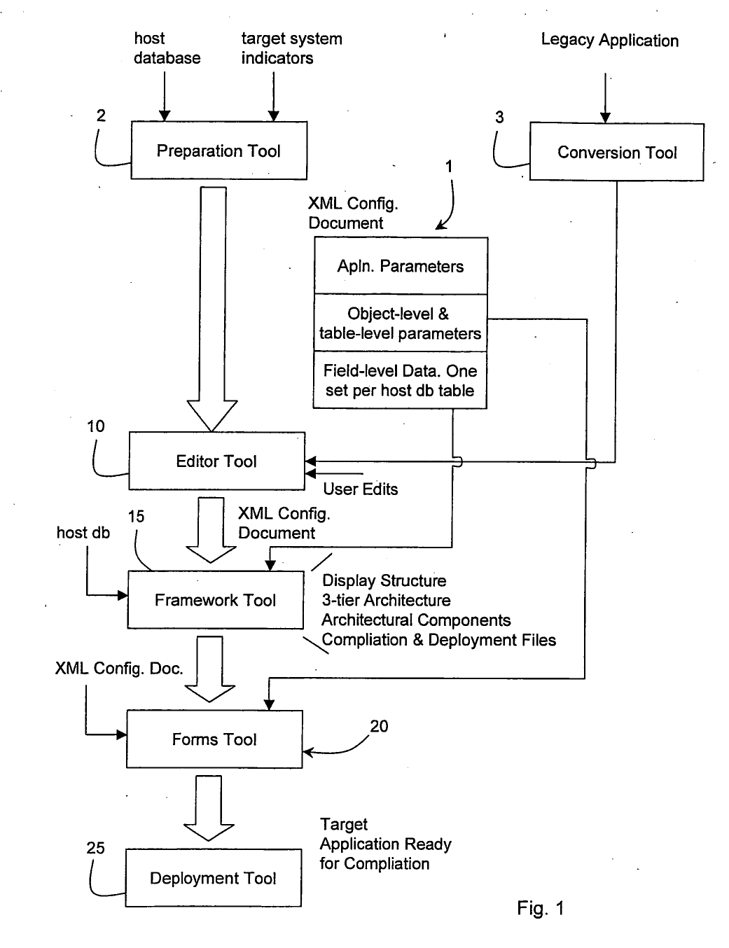

Referring to FIG. 1 a software development system of the invention starts with a source database or with a full source system. The development system comprises a configuration sub-system which generates an XM configuration document 1. This sub-system comprises a preparation tool 2 for generating the document 1 from only a source database, and a conversion tool 3 for generating the document 1 where there is a full source system. In the former case the system could be said to develop a target system, whereas in the latter case it migrates from source to a target system. Downstream processing after the document 1 is generated is similar whether there is development or migration.

An editor tool 10 allows controlled editing of the document 1, as described in more detail below.

A framework tool 15 includes pre-stored “skeleton” code. It automatically builds a directory structure architecture for end-product code and writes the “skeleton” code to this structure. The knowledge for building the architecture and writing the end-product code to it is derived from the XML configuration document and pre-stored code scripts which are constructed dynamically in accordance with data in the XML configuration document. The code is constructed by testing the data in the XML configuration document against a list of pre-stored alternatives. When a match is found, a relating pre-stored code script is selected, then data from the XML configuration document is inserted into pre-stored variables within the code script. After the process has looped through all the data in the XML configuration document, the code is then saved in a Java file format into the appropriate place within the architecture.

GUI forms for the target system are generated by a forms tool 20. This tool also uses the XML configuration document.

The end-product system has a three-tier model-view-controller structure, in which:
the model comprises the database and the programs developed by the framework tool,
the view layer comprises the forms generated by the forms tool, and
the controller comprises the programs for interpreting user gestures, such as typing on a keyboard and translating them into program events.

A deployment tool 25 integrates the outputs of the framework and form tools with the source database (for both development and migration) to deploy the target system.

The following describes the development tool and their operation in more detail.

Step I—Run the Preparation Tool 2

The preparation tool 2 is run on the source database executing on a host machine or across a suitable network. The purpose of the preparation tool is to create and populate the XML document 1 with three sections called V_UE_CONFIGURATOR_APPLICATION, V_UE_CONFIGURATOR_PARENT and V_UE_CONFIGURATOR. The tool populates sections with field attribute data taken from the source database and parameter data calculated by the tool. This data, together with the existing database structure must be present before the downstream tools can operate.

Inputs

1. JDBC Driver (e.g. oraclejdbc.driver.OradeDriver)
2. The host machine listen port address (e.g. exaltec_nt1:1521)
3. Database username
4. Database password
5. Database service name
6. The name and path of naming convention resource file or ‘None’
7. ‘Global’ to process all tables or a table name to process one table
8. The target application server product (e.g. BEA WEBLOGIC SERVER)
9. The target database type (e.g. ORACLE)
10. The target operating system (e.g. SUN SOLARIS)
   Processes
1. Establishes a JDBC connection with the specified database on the specified host machine.
2. Runs a script which builds the document 1 with three sections called V_UE_CONFIGURATOR_APPLICATION, V_UE_CONFIGURATOR_PARENT and V_UB_CONFIGURATOR.

3. The V_UE_CONFIGURATOR_APPLICATION section is populated with application-level parameter data such as the application name, path, the target application server, target database system and target operating system for deployment:

| XML Field Name | Value Set By The Process |
|---|---|
| COAP_ID | Automatically set by database |
| | sequence trigger |
| COAP_NAME | Application name as specified |
| | in input parameter |
| COAP_DELETED_DATE | Automatically set by database |
| | trigger |
| COAP_CREATED_DATE | Automatically set by database |
| | trigger |
| COAP_CREATED_USER_ID | Username |
| COAP_UPDATED_DATE | Automatically set by database |
| | trigger |
| COAP_UPDATED_USER_ID | Username |
| COAP_CLASS_PATH | The application class path |
| COAP_APPLICATION_SERVER | Target application server |
| | as specified in input parameter |
| COAP_DATABASE | Target database system |
| | as specified in input parameter |
| COAP_OPERATING_SYSTEM | Target operating system |
| | as specified in input parameter |

4. The V_UE_CONFIGURATOR_PARENT section is populated with object-level and table-level parameter data such as database table name, Enterprise Java Bean (EJB) name, EJB type, EJB Session facade name, details object name, tag library path, imported files and class definitions:

| XML Field Name | Value Set By The Process |
|---|---|
| COPA_ID | Automatically set by database |
| | sequence trigger |
| COPA_TABLE | Database table name |
| COPA_DELETED_DATE | Automatically set by database |
| | trigger |
| COPA_CREATED_DATE | Automatically set by database |
| | trigger |
| COPA_CREATED_USER_ID | Username |
| COPA_UPDATED_DATE | Automatically set by database |
| | trigger |
| COPA_UPDATED_USER_ID | Username |
| COPA_IDENTIFIER | The table name |
| COPA_EJB_SESSION_FACADE | Left blank |
| COPA_EJB_REMOTE_INTERFACE | Left blank |
| COPA_FORM_CONTROL_CLASSES | Filename |

5. The V_UP_CONFIGURATOR section is populated with field-level data. The tool 2 loops through each database table (excluding V_UE_CONFIGURATOR and system tables), building a data row set by extracting table names, field names, data types, field size and ‘Null’ permissions. The process adds this data to the CONF_TABLE, CONF_FIELD, CONF_DATA_TYPE, CONF_SIZE and CONF_NULLS XML fields of the V_UP_CONFIGURATOR section, providing the table field record does not already exist in it. If an XML field record already exists, the process updates the CONF_DATA_TYPE, CONF_SIZE and CONF_NULLS fields of the existing record.
6. As the process loops through each source database table, records containing primary key fields are detected (from database system table data) and omitted from the data result set. If however, the primary key of a particular table is detected in another table (i.e. a foreign key) the record from the other table is included. This is how table relationships are recorded in the V_UP_CONFIGURATOR section.

7. In addition, the process writes values into the other XML fields within the V_UE_CONFIGURATOR section. These fields can be described as parameter fields and are set with default values, using a nested, selection process. The CONF_FUNCTION XML field is set with the value ‘TEXT’ for all non-numeric field types (e.g. CHAR, VARCHAR2) and with the value ‘NUMBER’ for all other data types. If the user entered the path of a naming convention file when the preparation tool was launched then a further test is performed for setting the CONF_FUNCTION XML field. This file should contain a string to search for in the table field name, together with a corresponding value for the CONF_FUNCTION XML field. For example:

| If the database | CONF_FUNCTION |
|---|---|
| field name ends in: | XML field is set to: |
| ‘_NAME’ | ‘F_TEXT’ |
| ‘_DESCRIPTION’ | ‘F_DESCRIPTION’. |
| ‘_LKUP’ | ‘F_LKUP’ |
| ‘_CK’ | ‘F_CK’ |
| ‘_RD’ | ‘F_RD’ |
| ‘_TABLE’ | ‘F_TABLE’ |

This facility yields timesavings and accuracy for those who use naming conventions withintheir database.
8. The CONF_ID, CONF_DELETED_DATE, CONF_CREATEDDATE, CONF_CREATED_USER_ID, CONF_UPDATED_DATE and CONF_UPDATED_USER_ID are set automatically.

9. The following diagram shows each field in the V_UE_CONFIGURATOR table and how it is populated automatically by the process as it runs through the data row set:

| XML Field Name | Value Set By The Process |
|---|---|
| CONF_ID | Automatically set by database sequence |
| | trigger |
| CONF_TABLE | The table name |
| CONF_ORDER | The order of the field in the current |
| | table |
| CONF_FIELD | The field name |
| CONF_DATA_TYPE | The field data type |
| CONF_FUNCTION | (See point 6 above) |
| CONF_REFERENCE | Left blank |
| CONF_LABEL_1 | The field name |
| CONF_LABEL_2 | Left blank |
| CONF_DELETED_DATE | Automatically set by database trigger |
| CONF_CREATED_DATE | Automatically set by database trigger |
| CONF_CREATED_USER_ID | username |
| CONF_UPDATED_DATE | Automatically set by database trigger |
| CONF_UPDATED_USER_ID | username |
| CONF_SECTION_HEADER | Left blank |
| CONF_IDENTIFIER | The table name |
| CONF_NULLS | The field ‘NULLS’ permission |
| CONF_SIZE | Field data size |
| CONF_LABEL_3 | Left blank |
| CONF_DEFAULT | Left blank |
| CONF_OMIT_TYPE | Set to ‘OK’ |
| CONF_TABLE_COL_ORDER | The field order number in the current |
| | table |
| CONF_TABLE_COL_HEADER | The field name |
| CONF_TABLE_TAG_ATTRIBUTE | The table name concatenated to the |
| | field name |
| CONF_TABLE_ICON | Set to ‘0’ |
| CONF_TABLE_ICON_PATH | Left blank |
| CONF_TABLE_COL_CLASS | Set to ‘fieldTitle’ |
| CONF_TABLE_ROW_HEIGHT | Left blank |
| CONF_TABLE_COL_WIDTH | Left blank |
| CONF_TABLE_COL_FONT | Left blank |
| CONF_TABLE_COL_FONT_SIZE | Left blank |
| CONF_TABLE_COL_COLOUR | Left blank |
| CONF_TABLE_COL_OMIT | Set to ‘OK’ |
| CONF_TABLE_COL_ALIGN_H | Left blank |
| CONF_TABLE_COL_ALIGN_V | Left blank |
| CONF_TABLE_COL_BOLD | Left blank |
| CONF_TABLE_COL_ITALIC | Left blank |
| CONF_TABLE_BACKGROUND | Left blank |
| CONF_TABLE_ROW_BACKGROUND_1 | Left blank |
| CONF_TABLE_ROW_BACKGROUND_2 | Left blank |
| CONF_TABLE_BORDER | Set to ‘1’ |
| CONF_TABLE_CELLSPACING | Set to ‘0’ |
| CONF_TABLE_CELLPADDING | Set to ‘0’ |
| CONF_FIELD_CLASS | Set to ‘fieldTitle’ |
| CONF_FIELD_HEIGHT | Left blank |
| CONF_FIELD_WIDTH | Left blank |
| CONF_FIELD_IMAGE_PATH | Left blank |

The result of the above processes is that each table in the database has a set of corresponding records in the V_UE_CONFIGURATOR section. The V_UF_CONFIGURATOR section has now been prepared with data consisting of table field attributes and default parameter settings.

Outputs
1. V_UB_CONFIGURATOR_APPLICATION XML configuration document section populated with application-level attributes and default parameter settings.
2. V_UE_CONFIGURATOR_PARENT XML configuration document section populated with object-level attributes and default parameter settings.
3. V_UE_CONFIGURATOR XML configuration document section populated with field-level attributes and default parameter settings.
   Step II Editor Tool 10 Allowing Manual Setting of Parameter Data in the V_UE_CONFIGURATOR_APPLICATION, V_UE_CONFIGURATOR_PARENT and V_UE_CONFIGURATOR sections

Following Step I, there is now sufficient information for the framework tool 15 and the forms tool to create full, ready to deploy J2EE applications. However, in order for the applications to be meaningful the user will typically need to amend and fine-tune parameters, generate code and deploy a number of times. It is intended that business analysts should be capable of setting parameters, without the need for conventional programmers.

An editor tool 10 displays the document 1 with a navigator style representation of the application, modelling the target system, for the manual population of parameter fields with relevant values. The tool 10 is used in a first pass, and also in subsequent passes if necessary. Indeed it is particularly convenient for allowing subsequent passes to be made, enabling developers to regenerate the target system. Application components are displayed in a tree navigator structure. Users can write additional business logic code, demarcate their work and regenerate the model code without over-writing their work. The blueprint of each target system version is stored as document 1.

Inputs

The XML configuration document 1.

Processes

1. The user can amend the parameter data manually, either by typing directly into the document 1 as displayed on an editor form or by direct data entry into the V_UE_CONFIGURATOR section property sheets displayed on an editor.

2. The following diagram shows each field in the V_UE_CONFIGURATOR section and notes on how it may be populated manually by the user. Fields which are not permitted to be set manually are marked as N/A:

| | |
|---|---|
| XML Field Name | Value Set Manually |

| CONF_ID | N/A | |
|---|---|---|
| CONF_TABLE | N/A | |
| CONF_ORDER | Set the order of appearance of the field on | |
| | forms | |
| CONF_FIELD | N/A | |
| CONF_DATA_TYPE | N/A | |
| CONF_FUNCTION | This field is used for linking a form tag type | |
| | to the field. | |
| | Value: | Produces: |
| | F_TEXT | Text box |
| | F_DESCRIPTION | Text area |
| | F_LKUP | Selection list |
| | F_CK | Check box |
| | F_RD | Radio buttons |
| | F_TABLE | table |
| CONF_REFERENCE | If the CONF_FUNCTION field is set to | |
| | F_LKUP, the following parameters can be | |
| | entered. | |
| | Value: | Produces: |
| | A database table name and lookup field | The selection list will be populated with a list |
| | identifier | of corresponding lookup values from that |
| | | table |
| | A primary key identifier from | A button with a link to a form relating to the |
| | another table | other table for selecting a value |
| CONF_LABEL_1 | The user may set a form label for the field in | |
| | his/her own language | |
| CONF_LABEL_2 | Where CONF_FUNCTION is set to F_RD, | |
| | this can be used for adding a label to a radio | |
| | button set | |
| CONF_FIELD_CLASS | Select from ready-made field formats (created | |
| | by exaltec software) and used by Forms Tool: | |
| | Value: | Produces: |
| | pageTitle | font-family: Verdana, Arial, Helvetica, sans- |
| | | serif: font-size: 11px; color: #333333 |
| | areaTitle | font-family: Verdana, Arial, Helvetica, sans- |
| | | serif; font-size: 11px; color: #333333; line- |
| | | height: 10px |
| | fieldTitle | font-family: Verdana, Arial, Helvetica, sans- |
| | | serif; font-size: 10px; color: #333333; text- |
| | | align: right |
| | fieldText | font-family: Verdana, Arial, Helvetica, sans- |
| | | serif; font-size: 10px; color: #333333;; |
| | | vertical-align: middle |
| | inputField | width: 150px; font: 10px Verdana, Helvetica, |
| | | sans-serif: border: 1pt #454545 solid; color: |
| | | #333333; background-color: #FFFFFF |
| | textareaField | width: 410px; font: 10px Verdana, Helvetica, |
| | | sans-serif: border: 1pt #454545 solid; color: |
| | | #333333; background-color: #FFFFFF |
| | radioField | color: #454545; background-color: |
| | | #EFF9FE |
| | selectField | width: 150px; font: 10px Verdana, Helvetica, |
| | | sans-serif; border: 1pt #454545 solid; color: |
| | | #333333; background-color: #FFFFFF |
| | checkField | color: #454545; background-color: |
| | | #EFF9FE |
| | button | font-family: Verdana, Arial, Helvetica, sans- |
| | | serif font-size: 12px; border: 1pt #454545 |
| | | solid; color: #333333; background-color: |
| | | #CCCCCC |
| | blockBreak | line-height: 5px; font-size: 10px |
| CONF_FIELD_HEIGHT | Set the height of this field | |
| CONF_FIELD_WIDTH | Set the width of this field | |
| CONF_DELETED_DATE | N/A | |
| CONF_CREATED_DATE | N/A | |
| CONF_CREATED_USER_ID | N/A | |
| CONF_UPDATED_DATE | N/A | |
| CONF_UPDATED_USER_ID | N/A | |
| CONF_SECTION_HEADER | If a section header is entered, the | |
| | demarcation of a form section will be | |
| | created. The section will end either at the | |
| | next section header or at the end of the form. | |
| CONF_IDENTIFIER | The CONF_IDENTIFIER is used by the | |
| | Forms Tool in order to identify database | |
| | tables and fields for form building. Although | |
| | set by default to the table name, the user may | |
| | enter alternative unique identifiers. | |
| | This adds a further, important dimension of | |
| | complexity because it enables a database | |
| | table and all its fields to be recorded multiple | |
| | times and identified in the | |
| | V_UE_CONFIGURATOR table. A typical | |
| | use of this would be for building different | |
| | versions/operating modes of forms built | |
| | from the same database table. For example | |
| | an ‘Add’ form could be created with certain | |
| | fields omitted and an ‘Update’ form could be | |
| | created with those fields present. Another | |
| | identifier could be used to create a tabular | |
| | form for this database table and so on. | |
| CONF_NULLS | N/A | |
| CONF_SIZE | N/A | |
| CONF_LABEL_3 | Where CONF_FUNCTION is set to F_RD, | |
| | this can be used for adding a second label to | |
| | a radio button set | |
| CONF_DEFAULT | Where CONF_FUNCTION is set to | |
| | F_LKUP the user may enter a default | |
| | selection record_id from the lookup set. | |
| CONF_OMIT_TYPE | This can be set to ‘OMIT’ if the user wishes | |
| | to omit fields from appearing on forms. Set | |
| | by default to ‘OK’. | |
| CONF_TABLE_COL_ORDER | If a form is to be created representing data | |
| | from the table in tabular form, the user can | |
| | set the order in which fields will appear in the | |
| | table columns. | |
| CONF_TABLE_COL_HEADER | For tabular forms, the user can enter a | |
| | column header name. | |
| CONF_TABLE_TAG_ATTRIBUTE | For tabular forms, the table name | |
| | concatenated to the field name | |
| CONF_TABLE_ICON | For tabular forms, Set to ‘1’ to include the | |
| | image specified in | |
| | CONF_TABLE_ICON_PATH | |
| CONF_TABLE_ICON_PATH | For tabular forms, the name and path of an | |
| | image file (.GIF or .JPEG) | |
| CONF_TABLE_COL_CLASS | For tabular forms, select from ready-made | |
| | column formats (created by exaltec software): | |
| | Value: | Produces: |
| | pageTitle | font-family: Verdana, Arial, Helvetica, sans- |
| | | serif; font-size: 11px; color: #333333 |
| | areaTitle | font-family: Verdana, Arial, Helvetica, sans- |
| | | serif; font-size: 11px; color: #333333; line- |
| | | height: 10px |
| | fieldTitle | font-family: Verdana, Arial, Helvetica, sans- |
| | | serif; font-size: 10px; color: #333333; text- |
| | | align: right |
| | fieldText | font-family: Verdana, Arial, Helvetica, sans- |
| | | serif; font-size: 10px; color: #333333;; |
| | | vertical-align: middle |

| | |
|---|---|
| CONF_TABLE_ROW_HEIGHT | For tabular forms, specify row heights |
| CONF_TABLE_COL_WIDTH | For tabular forms, specify this column width |
| CONF_TABLE_COL_FONT | For tabular forms, specify column font |
| CONF_TABLE_COL_FONT_SIZE | For tabular forms, specify column font size |
| CONF_TABLE_COL_COLOUR | For tabular forms, specify column colour |
| CONF_TABLE_COL_OMIT | For tabular forms, To exclude a field |
| | column, set value to ‘OMIT’. Set to ‘OK’ by |
| | default |
| CONF_TABLE_COL_ALIGN_H | For tabular forms, set horizontal alignment |
| | of objects within the column (values L, C, R, |
| | blank) |
| CONF_TABLE_COL_ALIGN_V | For tabular forms, set vertical alignment of |
| | objects within the column (values T, M, B, |
| | blank) |
| CONF_TABLE_COL_BOLD | For tabular forms, set column text to bold |
| CONF_TABLE_COL_ITALIC | For tabular forms, set column text to italic |
| CONF_TABLE_BACKGROUND | For tabular forms, include a name and path |
| | of a file to produce a background effect for |
| | the table |
| CONF_TABLE_ROW_BACKGROUND_1 | For tabular forms, include a name and path |
| | of a file to produce a background effect for |
| | the first row and subsequent alternate rows |
| CONF_TABLE_ROW_BACKGROUND_2 | For tabular forms, include a name and path |
| | of a file to produce a background effect for |
| | the second row and subsequent alternate |
| | rows |
| CONF_TABLE_BORDER | For tabular forms, set the width of the table |
| | border in pixels |
| CONF_TABLE_CELLSPACING | For tabular forms, set cell spacing in pixels |
| CONF_TABLE_CELLPADDING | For tabular forms, set cell padding in pixels |
| CONF_FIELD_CLASS | Set to ‘fieldTitle’ |

Outputs

Revised XML configuration document 1, in three sections as set out above.

Step III—Build a J2EE Compliant, MVC Architecture Framework with the Framework Tool 15

The framework tool 15 uses data stored in the document 1, particularly in the V_UE_CONFIGUTRATOR section, to create a three-tier, architectural framework. The required architectural components are determined, code is generated and each component is automatically assembled and located in the appropriate part of the framework. The architecture framework is of the Model-View-Controller (MVC) type. In the MVC approach, the Model represents application data and the business rules that govern access and modification of this data. The View accesses data from the Model and specifies how that data should be presented. It also forwards user gestures to the Controller. The Controller defines application behaviour, interprets user gestures and maps them into actions to be performed by the model.

Each database table identified in V_UE_CONFIGURATOR_PARENT section has built for it a stateful session facade Enterprise Java Bean 2.+(EJB), an entity EJB, the middle-tier objects and application server deployment descriptors.

Inputs

1. V_UE_CONFIGURATOR_APPLICATION XML configuration document section prepared by the preparation tool and manually amended
2. V_UE_CONFIGURATOR_PARENT XML configuration document section prepared by the preparation tool and manually amended
0.3. V_UE_CONFIGURATOR XL configuration document section prepared by the preparation tool and manually amended
4. The existing database of the organisation
5. JDBC Driver (e.g. oraclejdbc.driver.OracleDriver)
6. A path ‘home’ directory where directories and files will be created
7. ‘Global’ to process all tables or an identifier string that exists in the CONF_IDENTIFIER field of V_UB_CONFIGURATOR table.
8. An application name and identification e.g. com.exaltecj2ee.app
   Processes
1. The framework tool 15 creates a directory structure in a specified home directory.
2. It copies a number of standard architecture files into the directory structure to create the architecture skeleton. These files include a request processor, request-to-event processor, Web-tier and EJB-tier controller objects for translating user gestures into business events, Struts framework, EJB Keys, Web Keys, JNDI Names, helper objects, and utility files.
3. Establishes a JDBC connection with the specified database on the specified host machine using data recorded in the V_UB_CONFIGURATOR_APPLICATION section.
4. Loops through each database table-field record in the V_UE_CONFIGURATOR section and performs the following:
5. Identifies the database table that is currently being processed in the V_UE_CONFIGURATOR section.
6. Builds a string containing EJB remote interface declarations.
7. Builds a string containing record create method fields for the EJB remote interface.
8. Builds a string containing record update method fields for the EJB remote interface.
9. Builds a string containing record retrieval method fields for the EJB remote interface.
10. Builds a string containing EJB home interface abstract declarations. To facilitate the functioning of database triggers, fields, which have associated database triggers set on the creation of records, are omitted. Because there is record creation, fields with associated update triggers are also detected and omitted.
11. Builds a string containing declarations of Container Managed Persistence (CMP) fields for the entity EJB bean.
12. Builds a string containing the entity EJB bean, create and post create methods, eliminating fields which have associated database triggers set on creation of records and fields with associated update triggers.
13. Builds a string containing create and update method fields for the controller event file.
14. Builds a string containing parameter requests for each form field for the Web handler files.
15. Builds a string containing field mappings for weblogic-cmp-rdbms-jar.xml
16. Builds a string containing CMP fields for ejb-jar.xml
17. Builds a string containing declarations for the EJB Details Model.
18. Builds a string for Session Facade Stateful Session EJB containing record create method fields.
19. Builds a string for Session Fapade Stateful Session EJB containing record update method fields.
20. Builds a string for Session Facade Stateful Session EJB containing record retrieval method fields.
21. Following completion of the loop (see point 4 above), the framework tool performs the following:
22. Using the entity EJB name, the other code elements within the EJB remote interface are generated and the EJB remote interface file is assembled using the string created in point 9 above. The file is named in accordance with a naming convention set by parameter data in the V_UE_CONFIGURATOR_PARENT and V_UE_CONFIGURATOR sections and saved in the appropriate position within the directory structure created in point 1 above.
23. Using the entity EJB name, other code elements within the EJB home are generated and an EJB home interface file is assembled using the strings created in points 6,7,8 & 9 above. The file is named in accordance with a naming convention and saved in the appropriate position within the directory structure created in point 1 above.
24. Using the entity EJB name, the other code elements within the EJB bean interface are generated and the EJB bean file is assembled using the strings created in points 11 & 12 above. The file is named in accordance with a naming convention and saved in the appropriate position within the directory structure created in point 1 above.

25. Using the Session facade EJB name, the other code elements within the Session facade EJB remote interface are generated and the Session facade EJB remote interface file is assembled using the string created in point 10 above. The file is named in accordance with a naming convention and saved in the appropriate position within the directory structure created in point 1 above.
26. Using the Session facade EJB name, the other code elements within the Session facade EJB home are generated and the Session facade EJB home interface file is assembled using the strings created in points 6,7,8 & 9 above. The file is named in accordance with a naming convention and saved in the appropriate position within the directory structure created in point 1 above.
27. Using the Session facade EJB name, the other code elements within the Session facade EJB bean interface are generated and the Session facade EJB bean file is assembled using the strings created in points 11 & 12 above. The file is named in accordance with a naming convention and saved in the appropriate position within the directory structure created in point 1 above.
28. A details model file is created using the EJB name plus ‘Model’ a prefix, the string created in point 14 above and a suffix. The file is named in accordance with a naming convention and saved in the appropriate position within the directory structure created in point 1 above.
29. Creates a controller event file using a prefix, the string built in point 13 above and a suffix.
30. Creates a Web handler file using a prefix, the string built in point 14 above and a suffix.
31. Creates a controller EJB helper file using a prefix, the string built in point 14 above and a suffix.
32. Concatenates a prefix string, the string created in point 15 and a suffix string to create the weblogic-cmp-rdbms-jar.xml extensible Markup Language (XML) file.
33. Concatenates a prefix string, the string created in point 16 and a suffix string to create the ejb-jar.xml AL file.
34. Builds a file containing AL request mappings.
35. Creates the weblogic-ejb-jar.xml file inserting the name of the entity EJB.
36. Creates build scripts Build.xml (used by ANT third party build software for compiling the components into an EAR file, ready for deployment onto application servers) and places these script files into the relevant directories within the structure created in point 1 above.

The V_UB_CONFIGURATOR PARENT and V_UB_CONFIGURATOR sections are used by the framework tool 15 as a reference to the tables in the existing database. Non-parameter data (such as data type) is always taken from the existing database tables and not the V_UB_CONFIGURATOR_PARENT or the V_UE_CONFIGURATOR section, ensuring that the framework tool always uses an up-to-date view of the database.

Outputs

The framework tool has built a directory structure, created a J2EE-compliant three-tier architectural skeleton, generated the architectural components based on the existing database, assembled the components into the appropriate place within the directory structure and generated the necessary files for compilation and deployment.

Step IV—Build Forms with the Forms Tool 20

The forms tool 20 uses data stored in the V_UE_CONFIGURATOR section and tables in the source database to create Java Server Page forms compatible with the architectural framework created by the framework tool 15. The user is able to select from a number of form templates or create their own template by manually amending parameters in the V_UE_CONFIGURATOR section. There are two ways that forms can be linked together within an application:

1. Dialog-Style Forms

As the forms tool 20 loops through data in the document 1, if a foreign key relationship is detected within a table and a ‘dialog’ style form has been specified (as an input parameter), a button is created for the corresponding form. This button will link to a search form. The search form is automatically created using the fields of the parent table. The purpose of the search form is to pass back a foreign key value to the child form, when the user is creating a new instance of the child form at run time. All parent and child ‘dialog’ style forms are linked via buttons and search forms.

2. Navigator Style Forms

As the forms tool loops through data in the document 1, if a foreign key relationship is detected within a table and a ‘navigator’ style form has been specified (as an input parameter), a navigator control will be created and the form will be accessed on the appropriate hierarchical level, pertaining to its parent-child position, as detected from the existing database. Search forms are not required since the navigator nodes maintain the value of the unique form keys.

Template files fall into three categories:
1. Java Server Page business applications. Form modes: ‘Normal’ or ‘Readonly’.
2. Java Server Page Portlets. Form modes: ‘Normal’ or ‘Readonly’.
3. Java Server Page Web Service applications. Form modes: ‘Normal’ or ‘Readonly’.

These templates can include dynamic variables, that is, variables whose value will change at run time. An example is the width of a form changing to accommodate forms of different sizes appearing alongside it on the screen.

Inputs

1. V_UE_CONFIGUTRATOR_APPLICATION XML configuration document section prepared by the preparation tool and manually amended
2. V_UE_CONFIGURATOR_PARENT XML configuration document section prepared by the preparation tool and manually amended
3. V_UE_CONFIGURATOR XML configuration document section prepared by the preparation tool and manually amended
4. An existing database.
5. JDBC Driver (e.g. oraclejdbc.driver.OracleDriver)
6. The host machine listen port address (e.g. exaltecnt1:1521)
7. Database username
8. Database password
9. Database service name
10. A template file name and path or ‘None’.
11. ‘Global’ to process all tables or an identifier string that exists in the CONF_IDENTIFIER field of V_UE_CONFIGURATOR section.
12. An application name and identification e.g. com.exaltecj2ee.app taken from the V_UE_CONFIGURATOR_APPLICATION section
13. Form-level page and file imports as defined in the V_UE_CONFIGURATOR_PARENT section
   Processes
1. The forms tool establishes a JDBC connection with the specified database on the specified host machine.
2. The process constructs X header prefix including Meta style, content and character set.
3. Constructs HTML field class declarations using parameter data recorded in the V_UE_CONFIGURATOR_PARENT section.
4. Adds a creation time and identity stamp
5. The form is named as a Java Server Page using a naming convention: “form”+EJB name+“.JSP”.
6. Defines top of a data block in HTML
7. Defines bottom of a data block in HTML
8. Defines a spacer HTML table
9. Defines the HTML form body and copies the basic form layout data from the template file. If no template is used, a basic two-column, form layout is created.
10. The form action is set using the form name.
11. If the CONF_FUNCTION field as a value of ‘F_TABLE’ the process will build the form as a tabular layout.
12. Creates the code for importing the details model object that corresponds to the session facade EJB and ultimately the database tables behind this form.
13. Creates the code that opens the Web-tier object, using the correct directory structure and specifies the scope of the form document.
14. Declares and initialises non-field related Java variables including page title, form action, dynamic field variables.
15. Loops through each database table-field record in the V_UE_CONFIGURATOR section, loads each row of data into a result set and performs the following:
16. Creates the code that will open the relevant tag libraries for the form fields. Uses the appropriate WebLogic 6.1 JSP Validation Tags if specified in the V_UE_CONFIGURATOR section or template file.
17. Declares and initialises Java field-related variables.
18. By testing the CONF_FUNCTION, CONF_REFERENCE and CONF_FIELD_CLASS fields in the V_UE_CONFIGURATOR section, the process builds HTML and Java code for each field control tag. The appropriate HTML layout code is generated for the field The Java code enables the field controls to be populated from the details model object at run-time. See CONF_FUNCTION field in Step I above, for the different control types.
19. Field control tags are positioned on the form in accordance with the template file. If a template file is not used, the process will automatically place fields in two vertical columns of the form layout, left to right. If the field control width is greater than the column width, it will be built on the next line down.
20. If the form mode is read-only, the HTML and Java code will be generated to show text and not an editable control tag.
21. If the field is a date field and the form mode is normal an additional button is created for date editing.
22. If the CONF_FIELD_MAGE_PATH field has a recognisable image file, the field will be deemed as an image field and code will be generated to display the appropriate image from the CONF_FIELD_MAGE_PATH field.
23. Radio button controls are created in the same HTML cell.
24. Field labels are set to the left of controls and if the form mode is normal, the alignment and formatting of text within controls is set in accordance with the parameter fields.
25. The process builds JavaScript code for the validation of form field controls.

By using the data in the CONF_LABEL_{—}1, CONF_NULLS and CONF_SIZE fields, it generates code that will popup a dialog, if the validation conditions are breached.
26. Generates code for function buttons, such as submit, reset, add, clone, save, back, forward, help and new. The process uses the buttons specified in the template or by default, submit and reset.
27. In the case of Web Service templates, Web Service Development Language (WSDL) code is generated for formulating peer-to-peer business queries. The forms tool generates a WSDL Directory for searching using UDDI and SOAP for communications over the Internet.
28. In the case of Portlet templates, the forms tool uses the portal framework application server-specific code in the template for deployment onto the appropriate application server.
29. Builds XML Screen definitions for use by the controller objects within the architectural framework.
   Outputs

The forms tool 20 is capable of generating an infinite variety of form styles, based on the template files and/or the parameters in the V_UE_CONFIGURATOR section. Because of the design of the MVC architecture, the forms are created with all the code required for linking to objects in the control tier and data tier. The forms are generated, ready to compile and deploy.

A deployment tool deploys the target software system onto an application server.

Migration/Conversion

The system of the invention also, in another mode, can start with a full source application and not just a database. Using the conversion tool 3, it operates a conversion process to convert the source application to generate an XML configuration document ready for processing by the editor 10, framework 15, and forms tools 20 to generate a target system. The development system of the invention operates in one or other mode: starting with a database only, or starting with a source application. The conversion tool selects inputs into an assimilation process, models new application components, allows manual population of parameter fields with relevant values, and runs an assimilation process;

The conversion tool 3 parses the source application and database, applying conversion rules, applying parameters, performing a decomposition of the schema into object oriented entities and generates a resultant XML configuration document containing a summary of the migrated application structure, database and parameter fields. The framework tool then generates target software code using the XML configuration document. The forms tool generates target forms using the XML configuration document. The system couples the organisation's database with the target code and the target forms to provide the target system.

The parameter fields include fields for selecting architectural framework styles, application components, screen controls, and the values are framework template names, application component names and screen control names. Also, the assimilation process combines multiple inputs and parameter field values and performs calculations in order to build parameter data that can be used to generate application architecture, components and functionality and stores this data in a document 1.

Once the conversion tool 3 has operated, the XML configuration document 1 is fed into the editor tool, as illustrated in FIG. 1. The remainder of the process is as for Steps II, III, and IV described above.

Configuration Sub-system: Preparation & Conversion Tools

The configuration sub-system includes a default global XML configuration file. This provides a base for generating the document 1. A parameter editor program enables users to easily update the default values in a global XML configuration file. The sub-system also includes a default migration conversion rules XML file. A conversion rules editor program enables users to easily add, update and remove the migration conversion rules in the global migration conversion rules X file. An application conversion program models application components, generates an application XML configuration file, migrates code, and generates code. Also, an application editor program remodels the application components, regenerates the application XML configuration file, regenerates application code, and generates code required to deploy the target system.

Initially, the user can set the values of a number of parameters using the parameter editor program. These values are used later by the application conversion program and application editor program to provide default values for screen fields. These default values are maintainable in the parameter editor program, separate to the application wizard and application editor, so that the user can provide a default component model and default ‘look and feel’ for all the applications they generate. The values of the parameters are stored in the global XML configuration document file which is written to the user's computer system. The parameters displayed in the parameter editor program, themselves have default values which are drawn from the default global XML configuration file that is shipped with the software. On first time use, when the users launches the parameter editor program, the program loads the default global XML configuration file from the file system and copies it to create the global XML configuration document. Any changes made by the user are saved to this new file.

Operation of the conversion tool is described in more detail below. The tool concatenates stored String variables with the project name entered in by the user to create three project names, stored as String variables. The three project names will be used to create three J2EE projects: an application project, an EJB project and a Web project. These three projects will contain Java artefacts that will constitute the components of an industry-recognised model-view-controller architecture model. For example if the project name entered was ‘Test’ the three project names created are:
‘b+Test’—this is the application level project name
‘TestEJB’—this is the EJB project name
‘TestWeb’—this is the Web project name

The tool checks the file system to ensure that no other project files exist with these names. If they do the program raises an error, posting the error to an error log file and displaying an error dialog box where the user can cancel the execution of the Application Wizard program. The program creates the three project directories and project files in the file system with the names created in the previous step. The program accesses the values stored in the Global XML. Configuration file memory array and builds a new XML file called the application XML configuration file. For screen controls the value name-value pairs are stored in a nested XML structure.

This file contains value name-value pairs that are specific to the target application.

This file is built using the following process:
Create an empty file in the file system in the application project directory (created in step c), called b+Editor.XML.
Use string concatenation, using pre-stored XML skeleton code and the values referred to in step d, to construct the file contents with value name-value pairs. For screen controls such as a navigator control, loop through each branch of the navigator and concatenate a corresponding nested XML structure.
Write the concatenated string to the b+Editor.XML file

The tool 3 determines if the user has selected the source migration system and the source files for migration by reading the empty or populated values for the corresponding value name-value pairs in the b+Editor.XML. If these values are selected the migration process is initiated by the program. This process performs the following:
Loads the migration source files from the file system into memory arrays
Loads the global migration conversion rules XML file from the file system.
Loads the application XML configuration file from the file system.
Loads the navigator control and property sheet control on to determine whether modelled application components have been associated with source migration (form) files.
Locates the correct source migration category within the global migration conversion Rules XML file, (based on the value set in Wizard Screen1-iii as read from b+Editor.XML)
For each source migration file array, the program parses the source code by attempting to match sections of the source code with the search criteria specified in the conversion rules.

For example, there may exist the following conversion rule:

```
<category name=”ORACLE Developer 2000 Forms”>
<rule id=“ORACLE47” category=“Record Sets” provider=“Exaltec”>
        <search name=“selection field”, value=“validate(lookup (”>
            <search name=“selection operator”, value=“find”>
                <conversion name=“java slct” value=“select”>
                </conversion>
            </search>
        </search>
</rule>
</category>
```

This is a simple nested conversion rule which relates to a selection list form field. If that says if the string ‘validate(lookup’ is encountered during source migration file array parsing, then perform a search for a subsequent occurrence of the string “find”. If both these strings are found in sequence, then write the value “select” into the corresponding field value name-value pair for this form, in the Application XML Configuration file. This assumes that the user associates a legacy migration (form) file with an application component. Code parsing and searching is performed using standard Java commands such as ‘.indexOf( )’

Thus, the conversion tool parses the source code, looping through all of the conversion rules. One rule is applicable, and it selects an appropriate parameter to insert in the configuration document 1.

Once the application XML configuration file has been constructed using the processes described above, the next task for the program is to generate the java artefacts (application directories and files). The program performs this process by opening the application XML configuration file and loading the XML value name-value pairs for each nested XML structure. For each structure a lookup list (stored as hard code within the program) is referenced to identify the following:
An artefact file name is selected from the lookup
An artefact file extension (e.g .java, .xml)
Code java package name
Code library imports
Code variable names
Code methods

When an application component is identified in the XML structure, such as a read-only form, the form is created in the file system by this process using the file name and extension in i and ii above. Next, the java source for this file is built by concatenating strings from the lookup list iii-vi above with the values stored in the XML structure. This process is used to create all the different types of java artefacts such as EJB java files, JSP Java Server Pages files, XML files, CSS files and more. The files are written in accordance with the directory structure listed in the lookup list and placed under the appropriate project directories created in step c.

For example if the process encounters the following form-level AL structure:

```
<object name=“b+FUNCCLONE:Table Mask1”>
    <parameter name=“style” value=“DIALOG1”></parameter>
    <parameter name=“mode” value=“READ ONLY”></parameter>
</object>
```

Next using the nested structure of this XML, the lookup list provides ready-made skeleton code snippets to provide the appropriate java code methods to fulfill the “style” and “mode” values. The process concatenates the skeleton code snippets with the values listed above in order to provide the correct java code. In the above example, the process searches the lookup list for a list item name matching the XML string “b+FUNCCLONE:Table Mask1” Next, the process reads the values from the lookup list associated with this item name. The lookup list provides a file name and extension: TableMask1.jsp and provides the set of java methods (as java code) required for a Clone JSP form.

In this example the process encounters the following field-level XML structure:

```
    <object name=“b+FUNC_FIELD:TableMask1:RASDA:
    AIRCRAFT:WS3_DESC”>
        <group name=“field header”>
<parameter name=“data type” value=“VARCHAR2”> </parameter>
```

In this example the process has to locate the TableMask1.jsp form file that it created in the previous step, open the file and use the lookup list to construct java code that declares these variable names and assigns the values listed above to them. The value “VARCHAR2” is parsed from the AL structure above and passed to the lookup list which returns ‘String’. The “WS3_DESC” is parsed from the XML structure above and provides us with our field name. The “b+FUNC_FIELD” is parsed from the L structure above and passed to the lookup list which returns our declaration method. The three strings are then concatenated by the process using a hard coded pattern, to produce this sample code which is inserted into the TableMask1.jsp file:

```
    /**
      * @generated
      */
private String WS3_DESC;
```

This process is used to construct all the java and HTML code within the java artifacts. The pre-tested values stored in the Lookup list and the pattern used by the process to build them into java code ensures that the artifacts do not contain coding errors and will deploy on leading application servers. Note: The pattern referred to here is simply a procedure of program code that loops through the Application XML Configuration file as described above and follows a sequential process of identifg XML structures, parsing the XML values from the structures, searching the lookup list and using the results of the search to construct the files and code as described above.

The application editor program performs exactly the same processes as described above except that it does not need to perform the steps used to initially create the application XML configuration file from the Global XML configuration file. It just works with the application XML configuration file initially created. The application editor program enables the user to add, update and delete the parameter values stored in b+Editor.XML (the application XML configuration file). The user can then run the application generation and migration processes described previously to regenerate their java artefacts (overwriting the existing ones).

A procedure exists for demarcating manual code and storing it in a task list file prior to overwriting the java artefacts.

It will be appreciated that the invention allows for much quicker systems development. It is particularly advantageous for conversion of two-tier client/server application into three-tier MVC systems, through the application of conversion rules. Because coding is done by the invention, there is total accuracy and consistency in the thousands of lines of code produced. The invention does not just deal with a section of the software development, it produces all the code necessary for deployment to a variety of platform configurations. Therefore it is a tool that can be used by business analysts, without the need for conventional programmers.

The invention is not limited to the embodiments described but may be varied in construction and detail.

1-33. (canceled)

34. A software development system for development of a target software system, the development system comprising:
a configuration sub-system for automatically generating configuration data by processing a source database, the configuration sub-system comprises a preparation tool for parsing a source system database to generate the configuration data, the preparation tool extracting application-level parameter data from the source database to provide at least some of the configuration data and the preparation tool further extracting object-level and table-level parameter data from the source database including class definitions to provide at least some of the configuration data;
a framework tool for using said configuration data to automatically generate a target system architecture and program code and for populating the architecture with the program code, the framework tool pre-storing standard architecture files including a request processor and request-to-event processor controller objects, and writing them to the target system architecture, the framework tool also pre-storing helper objects and utility files and writes them to the target system architecture;
an editor tool for generating a display of the configuration data in a navigation structure, and for allowing manual editing of selected fields of configuration data with data field-level access control; and
a forms tool for automatically building target system user interface forms.

35. The development system as claimed in claim 34, wherein the preparation tool loops through tables of the source database to build field-level configuration data including table names, field names, data types, and field size.

36. The development system as claimed in claim 35, wherein records containing primary key fields are omitted.

37. The development system as claimed in claim 36, wherein foreign keys are included.

38. The development system as claimed in claim 35, wherein the preparation tool generates at least some configuration data using default values in a nested selection process.

39. The development system as claimed in claim 35, wherein the preparation tool populates the configuration document with a set of field-level parameter values corresponding to each table in a source database.

40. The development system as claimed in claim 35, wherein the field-level data includes default parameter settings derived from source database fields.

41. The development system as claimed in claim 34, wherein the configuration data is in a mark-up language format in a configuration document.

42. The development system as claimed in claim 41, wherein the configuration document has a section for each of application-level data, object and table-level data and field-level data.

43. The development system as claimed in claim 34, wherein the editor tool allows a single table of the source database to be represented multiple times in the configuration data.

44. The development system as claimed in claim 35, wherein the framework tool parses the field-level configuration data to generate:
a program code string for remote interface declarations,
a program code string containing record create method fields for a remote interface, and
a program code string containing record update method fields for a remote interface.

45. The development system as claimed in claim 35, wherein the framework tool parses the field-level configuration data to generate program code containing home interface abstract declarations, to generate program code containing create and update method fields for a controller event file, and to generate program code containing parameter requests for each form field for web handler files.

46. The development system as claimed in claim 34, wherein the framework tool pre-stores skeleton code and writes said code to the target system architecture.

47. The development system as claimed in claim 34, wherein the framework tool generates the target system architecture according to the Model-View-Controller paradigm, in which a model represents application data and business rules, a view accesses data, and a controller defines application behaviour.

48. The development system as claimed in claim 34, wherein the forms tool automatically identifies field-level configuration data associated with user-editable fields, detects the nature of the user input, and generates a corresponding form control.

49. The development system as claimed in claim 48, wherein the forms tool automatically identifies a dialog input parameter in the field-level configuration data and generates a corresponding input button for a form.

50. The development system as claimed in claim 34, wherein the configuration sub-system comprises a conversion tool for automatically converting source system application programs to configuration data, and the framework tool operates with said configuration data.

51. The development system as claimed in claim 50, wherein the conversion tool stores conversion rules for operating with the source system application programs to generate the configuration data.

52. The development system as claimed in claim 50, wherein the conversion tool parses the source application programs, applies conversion rules to said programs, applies parameter values, and performs a decomposition of the source application program schema into object-oriented entities to provide configuration data representing source application structure, database, and application fields.

53. The development system as claimed in claim 52, wherein the schema represents modelled source application reusable objects.

54. The development system as claimed in claim 41, wherein the configuration sub-system comprises a default global configuration document, and an editor program to allow user editing of said document.

55. The development system as claimed in claim 50, wherein the conversion tool comprises a default conversion rules files, and an edit program to allow user updating of migration conversion rules.

56. The development system as claimed in claim 50, wherein conversion tool parses source system code by looping through all of a set of a conversion rules for each element of source code.

57. The development system as claimed in claim 56, wherein one of said rules selects a corresponding parameter to insert in the configuration data.

58. A software development system for development of a target software system, the development system comprising:
a configuration sub-system for automatically generating configuration data by processing a source application, the configuration sub-system comprising a conversion tool for automatically converting source system application programs to configuration data, the conversion tool storing conversion rules for operating with the source system application programs to generate the configuration data; a framework tool for using said configuration data to automatically generate a target system architecture and program code and for populating the architecture with the program code, the framework tool pre-storing standard architecture files including a request processor and request-to-event processor controller objects, and writing them to the target system architecture, the framework tool also pre-storing helper objects and utility files and writes them to the target system architecture;
an editor tool for generating a display of the configuration data in a navigation structure, and for allowing manual editing of selected fields of configuration data with data field-level access control; and
a forms tool for automatically building target system user interface forms.

59. The development system as claimed in claim 58, wherein the conversion tool parses the source application programs, applies conversion rules to said programs, applies parameter values, and performs a decomposition of the source application program schema into object-oriented entities to provide configuration data representing source application structure, database, and application fields.

60. The computer program product comprising software code for performing operations of a development system of claim 34 when executing on a digital computer.

61. The computer program product comprising software code for performing operations of a development system of claim 58 when executing on a digital computer.
